(19) United States
(12) Patent Application Publication
(10) Pub. No.: US 2024/0342966 A1
(43) Pub. Date: Oct. 17, 2024

(54) METHOD FOR PRODUCING A MOLDED PART

(71) Applicant: Knauf Industries Additive GmbH, D-53797 Lohmar (DE)

(72) Inventor: Simon Scheuer, Lohmar (DE)

(73) Assignee: Knauf Industries Additive GmbH, D-53797 Lohmar (DE)

(21) Appl. No.: 18/368,733

(22) Filed: Sep. 15, 2023

(30) Foreign Application Priority Data
Sep. 21, 2022 (EP) 22196831.6

(51) Int. Cl. B29C 44/34; B29C 44/02; B29K 23/00; B29K 105/04

(52) U.S. Cl. CPC B29C 44/343; B29C 44/02; B29K 2023/12; B29K 2105/04; B29K 2905/00

(57) ABSTRACT

A method for producing a molded part from a foamed plastic in a mold cavity which is delimited by walls of an at least two-part, open- and closable molding tool including the steps: closing of the molding tool to prepare the mold cavity; pouring a particulate granulate of the plastic into the mold cavity; heating the granulate through the introduction of steam into the filled mold cavity at such a temperature and steam pressure that the granulate expands and is melted to form a molded part; cooling the molded part in the mold cavity; opening the molding tool and removal of the molded part, wherein the steam that is introduced into the mold cavity is conveyed through steam chambers which are positioned on the side of the walls of the molding tool opposite from the mold cavity and communicate with the mold cavity by openings that pass through the walls, and wherein before and/or during the closing of the molding tool, a temperature control medium inside the walls of the molding tool is guided in a cavity which does not communicate with the steam chambers and mold cavity, in order to preheat the walls, and the walls of the molding tool are preheated to a temperature that is suitable for the melting of the granulate to form the molded part.

### CROSS REFERENCE TO RELATED APPLICATION

European Patent Application No. EP 22196831.6, filed 21 Sep. 2022, the priority document corresponding to this invention, to which a foreign priority benefit is claimed under Title 35, United States Code, Section 119, and its entire teachings are incorporated, by reference, into this specification.

### BACKGROUND OF THE INVENTION

### Field of the Invention

This invention relates to a method for producing a molded part from a foamed plastic in a mold cavity, which is delimited by walls, of an at least two-part, open and closable molding tool. Such a method, which is also commonly called a particle foaming method, usually comprises the steps: closing of the molding tool to prepare the mold cavity; pouring of a particulate granulate of the plastic into the mold cavity; heating of the granulate through the introduction of steam into the filled mold cavity at such a temperature and steam pressure that the granulate is melted to form a molded part; cooling of the molded part in the mold cavity; opening of the molding tool and removal of the molded part, wherein the steam that is introduced into the mold cavity is conveyed through steam chambers, which are positioned on the side of the walls of the molding tool opposite from the mold cavity and communicate with the mold cavity via openings that pass through the walls.

### Discussion of Related Art

For example, European Patent References EP 0 259 597 A2 and EP 2 227 366 B1 are known prior art.

To heat the walls of the mold cavity and to simultaneously or subsequently heat the granulate, in the prior art, usually after the molding tool is closed and after the particulate granulate has been poured in, steam is introduced into the mold cavity, which heats the walls to the desired temperature and causes the particulate granulate in the mold cavity to melt. This steam, however, undesirably results in the formation of condensate, which settles on the walls of the mold cavity and negatively affects the shape and/or surface quality of the resulting molded part. In addition, the steam chambers must be embodied to be relatively voluminous so that the molding tools have a correspondingly large volume, which entails correspondingly large dimensions for the entire molding machine.

European Patent Reference EP 2 227 366 B1 therefore proposes for this steam to be removed from the mold cavity through application of a negative pressure. But this additional work step lengthens the cycle time for the production of a molded part.

In addition, producing the large quantities of steam required is energy-intensive and requires large quantities of water and the steam that is removed from the mold cavity leads to undesirably high quantities of moisture outside the molding tool.

European Patent Reference EP 2 875 928 A1 and European Patent Reference EP 3 088 153 A1 also disclose molding tools for producing molded parts in the particle foaming method, which molding tools because they are produced from metallic materials in an additive method, for example by selective laser welding can also have fine hollow structures with integrated conduits and openings of the kind that cannot be produced with conventional material-removing methods and casting methods.

### SUMMARY OF THE INVENTION

One object of the invention is to provide a method of the type mentioned above, which overcomes the disadvantages of the prior art through particularly low cycle times and particularly low energy and water consumption as well as compact dimensions of the molding tools used.

To attain the stated object and other objects, this invention provides a method according to the features described in this specification and in the claims, including embodiments and modifications of this invention described in the dependent claims.

In the solution according to this invention, inside the walls of the molding tool, a temperature control medium is guided in a cavity, which does not communicate with the steam chambers and mold cavity, in order to preheat the walls, and the walls of the molding tool are preheated to a temperature that is suitable for the melting of the granulate to form the molded part. According to this invention, this preheating can already take place before the closing of the molding tool. Thus according to this invention, the preheating of the walls can already be initiated before and during the closing of the at least two-part molding tool and/or during the filling procedure of the mold cavity prior to the introduction of the steam, which can save a considerable amount of process time in comparison to the prior art. In the prior art, it was necessary to first wait for the complete closing and filling of the molding tool and the accompanying formation of the mold cavity before a blast of steam from the steam chambers could be delivered into the mold cavity for the heating. This thus led to the formation of an enormous amount of condensate, which was then present in the molded part and caused the known problems.

The cavities, which according to this invention are provided in the walls of the molding tool and in which a temperature control medium can be guided in such a way that it does not communicate with the steam chambers and mold cavity, can be formed in particular by producing the molding tool using an additive method.

According to this invention, the molding tool used in the method thus has a total of three levels that are temperature controlled independently of one another, namely in accordance with the prior art, the steam chambers on the one hand and the mold cavity on the other and in addition to the prior art, the cavity, which is situated inside the walls of the molding tool and does not communicate with the steam chambers and mold cavity, as the third temperature control level.

In particular, steam is used as the temperature control medium in the method according to this invention. Alternatively, however, other suitable temperature control mediums such as water, oil, or mixtures thereof are also possible options.

According to this invention, the walls are preheated to a suitable temperature, which according to one proposal of this invention, is approximately 100 to 200° C., such as from about 110° C. to 150° C., preferably 140° C., when processing expanded polypropylene (EPP), wherein the temperature is freely selectable and is selected by the person skilled in the art as a function of the plastics that are to be processed.

The proposed preheating of the walls of this invention by the temperature control medium, which is guided inside the walls and does not communicate with either the mold cavity or the steam chambers, also offers the advantage that the mold cavity does not come into contact with steam during the preheating and the steam therefore also does not precipitate as condensate in the mold cavity and have to be removed from it again at great expense.

The steaming times in one step of this invention for heating the granulate, possibly expanding it, and melting it to form a molded part can, according to the method of this invention, turn out to be extremely short since only the energy, which is required for plasticizing the particles of the molded part that is to be produced and for heating the cavity between the individual particles, has to be applied by introducing the steam into the filled mold cavity so that almost no condensate forms and to this extent, molded parts with outstanding surfaces are produced.

Because of the only small quantities of steam required in the steam chambers, which steam quantities have to be introduced into the mold cavity to heat the granulate, it is also possible for the steam chambers themselves to be embodied as correspondingly compact so that the dimensions of the molding tool used in the method according to this invention can be reduced significantly in comparison to the prior art.

According to another embodiment of this invention, the guidance of the temperature control medium through the cavity can also be maintained during the pouring-in of the granulate in one step and/or during the heating of the granulate in another step according to this invention.

In addition, the temperature control medium can be guided through the cavity in a closed circuit in order to further optimize energy and water consumption.

According to another embodiment of this invention, after one heating step the filled mold cavity is acted on with negative pressure. Thus, right after the introduction of the steam into the filled mold cavity in order to heat the granulate and melt it to form the molded part, in the shortest possible time after the desired amount of energy has been introduced into the particles contained in the mold cavity, this steam is removed from the mold cavity again in order to stabilize the resulting sintered molded part by utilizing the residual heat inherent in the molded part and the walls of the molding tool. For this purpose, the negative pressure is preferably maintained at a temperature of the walls of at least 70° C., preferably about 110° C. with EPP, for a predetermined time interval that is required to stabilize the melted particles in the mold cavity. Alternatively, the foam pressure of the molded part that is produced can be measured, for example, by a probe that is inserted into a wall that delimits the mold cavity. As soon as this foam pressure falls below a predetermined threshold, it can be concluded that the stabilization of the melted particles in the mold cavity has been successfully completed. Any condensate still present in the mold cavity is also transformed back into the vapor phase by the negative pressure applied and is discharged from the mold cavity via the openings into the steam chambers and removed from there.

For example, the negative pressure can be produced by negative pressure pumps or also by a vacuum tank, for example as described in European Patent Reference EP 2 227 366 A1.

According to another embodiment of this invention, in one step a cooling medium can then be conveyed through the cavity inside the walls of the molding tool, which cavity does not communicate with the steam chambers and mold cavity and through which the temperature control medium has also been conveyed in the preceding step in which the walls are preheated. In this way, the walls can be rapidly cooled to a demolding temperature without the molded part coming into contact with the cooling medium.

According to another embodiment of this invention, the application of negative pressure on the mold cavity can continue during and/or after the conveying-through of the cooling medium and the cooling of the walls.

According to another embodiment of this invention, the cooling medium can be guided in a closed circuit.

Because of the proposed preheating of this invention of the walls of the mold cavity by a temperature control medium that is guided in a cavity in the walls, no condensate is transported into the as yet unformed particulate foam of the molded part and the introduced energy quantity in the molded part is so low that the produced molded part exhibits only a reduced shrinkage tendency. The stabilization times in the molding tool are thus extremely short and it is even possible if necessary to dispense with tempering periods that have been unavoidable thus far in the prior art.

Because both the heating of the walls of the molding tool and the cooling thereof take place by a respective temperature control medium and cooling medium that are guided in the closed cavity of the walls, in the method according to this invention, individual method steps can be carried out in parallel, which significantly reduces cycle times and enables enormous energy savings.

In another embodiment of the method according to this invention, before, during, and/or after the heating of the granulate in one step and before the cooling of the molded part, a very hot temperature control medium with a raw material-dependent temperature of approximately 150 to 200° C., preferably approximately 170 to 180° C., is conveyed through the cavity. Through the resulting intense heating of the walls that delimit the mold cavity, it is possible to produce a closed plastic skin on the molded part, which is particularly desirable in certain applications. The melted volume fraction of the granulate is compensated for by a second filling process or the compression of the component by the so-called “compression in the gap”.

The method according to this invention can be carried out with molding tools that have cavities or conduits, which are contained in the walls delimiting the mold cavity and through which the temperature control medium and possibly also the cooling medium can be conveyed without the occurrence of a contact with or overflow into the mold cavity and steam chambers. In particular, molding tools are considered to be suitable if they are produced from metallic materials using an additive method, for example, by selective laser welding. With this method, walls of the molding tool can be produced that have an ideally contiguous cavity between the surfaces that adjoin the mold cavity on the one hand and the steam chamber on the other, wherein the openings that connect the steam chambers and the mold cavity for purposes of introducing and discharging steam are embodied as tubular segments that are isolated from the cavity and pass through the cavity. Because of the production using an additive method, both the surfaces that delimit the cavity and the openings provided therein are integrally produced from the metallic material, wherein the positioning and course of the openings can be selected with a large degree of freedom as a function of the molded part that is to be produced. The molding tools are equipped with suitable connection fittings for conveying the temperature control medium and possibly the cooling medium through the cavity.

### BRIEF DESCRIPTION OF THE DRAWINGS

Other modifications and details will be explained below based on the drawings, which show an exemplary embodiment, wherein:

FIG. 1 shows a section through a subregion of a molding tool; and

FIGS. 2 to 6 are schematic drawings showing partially sectional views of the molding tool showing the sequence of the method according to this invention in successive steps for producing a molded part.

### DETAILED DESCRIPTION OF THE INVENTION

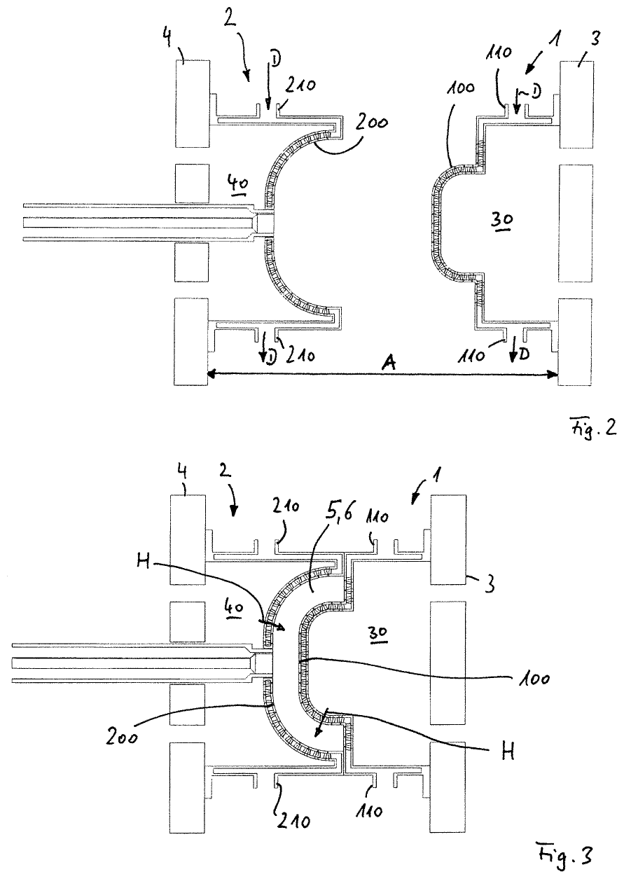

In sequential order, FIGS. 2 to 6 show the production of a molded part 6 in a two-part molding tool with a first upper mold part 1 and an associated second lower mold part 2, which are fastened, for example in monoblock fashion, to supporting plates 3, 4 of a molded part machine that is not shown in detail.

By drive units that are not shown in detail, the molding tools 1, 2 can be moved into the open state shown in FIG. 2 and, by reducing the distance A, can be moved into a closed state shown in FIG. 3, which will be explained in greater detail below.

The two molding tools 1, 2 have a contour of the molding tool wall 100, 200 that is embodied in accordance with the molded part that is to be produced and in the closed state shown in FIG. 3, delimit a mold cavity 5 in which the molded part 6 is produced in the manner that is explained in greater detail below.

On the respective side of the wall 100, 200 opposite from the mold cavity 5, a respective steam chamber 30, 40 is delimited between the mounting plate 3, 4 and the molding tool 1, 2 that is fastened to it, which steam chambers, in a manner not shown in greater detail, are equipped with connecting openings for the supply and discharge of steam and/or the application of negative pressure.

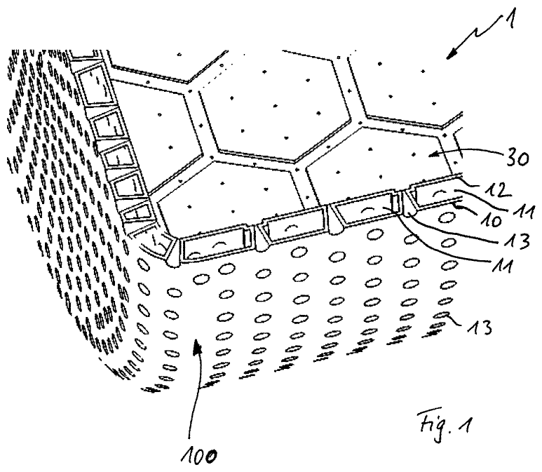

An essential feature of the two molding tools 1, 2 is that they are produced using an additive method from metallic materials such as rust-free stainless steel (V4A) for example by selective laser welding and have the structure shown in FIG. 1.

In the example of the molding tool 1 that constitutes or forms the upper part, a hollow structure of the wall 100 is visible, which is likewise embodied in the wall 200 of the molding tool 2 that constitutes or forms the lower part so that the explanations below also apply equally to the molding tool 2.

Accordingly, the wall 100 is delimited by a surface 10 that faces and delimits the mold cavity and by a second surface 12 adjacent to the steam chamber 30 and spaced apart from the surface 10, between which a continuous cavity 11 is formed, which is penetrated by tubular or columnar openings 13 extending from the surface 12 to the surface 10 and widening with a circular cross-section in a funnel-shaped or conical manner in the direction toward the surface 10. The openings 13 are thus delimited relative to the cavity 11, but permit matter to pass between the steam chamber 30 and the mold cavity 5 adjoining the surface 10. The cross-sectional structure of the walls 100, 200 with two surfaces 10, 12 spaced apart from each other and with an interposed cavity 11 and tubular openings 13 passing through the cavity 11 produces an extremely lightweight and rigid structure of the molding tools 1, 2.

On the other hand, the cavity 11 in the molding tool 1 is provided with or comprises at least two connection fittings 110 as an additional function level so that a medium can be conveyed through the cavity 11 via the connection fittings 110 without its being able to travel out of the cavity 11 and into the steam chamber 30 or mold cavity 5 since the openings 13 are partitioned or sealed off from the cavity 11.

The same applies to the structure of the wall 200 in the molding tool 2, where the connection fittings are labeled with the reference numeral 210.

To produce a molded part from a foamed plastic inside the mold cavity 5, starting from the open state in FIG. 2, in a first step while the molding tool 1, 2 is still open, a temperature control medium, for example steam, at a temperature of approximately 130° C. and a regulated pressure of approximately 3 bar is guided according to the arrows D via the connection fittings 110, 210 through the cavities 11 in the walls 100, 200 of the molding tools 1, 2 in order to preheat the molding tools 1, 2 in the region of their walls 100, 200 and the surfaces 10, 12 delimiting these walls to the for the melting of the particulate granulate made of plastic to form a molded part, for example, to a temperature of greater than or equal to 120° C.

Because of the guidance of the temperature control medium, in this case steam, through the cavity 11 formed inside the walls 100, 200, a homogeneous preheating of the walls 100, 200 is achieved without steam being able to travel into the steam chamber 30 or mold cavity 5 or onto the surfaces 10, 12 that delimit them and precipitate there to form condensate.

Simultaneously with the preheating of the walls 100, 200, the molding tools 1, 2 together with the associated supporting plates 3, 4 are moved toward each other by reducing the distance A between them until the closed position shown in FIG. 3 is reached, in which they engage with each other and delimit the closed mold cavity 5 between themselves.

The preheating of the walls 100, 200 can be maintained throughout the entire closing process, resulting in a significant time savings.

As soon as the mold cavity 5 is formed between the two molding tools 1, 2, particulate granulate of the plastic is poured into the mold cavity 5 via corresponding filling openings in the walls 100, 200, wherein if necessary, the preheating of the walls 100, 200 can still be maintained by the temperature control medium that is guided in the cavities 11.

As soon as the filling of the mold cavity 5 with the granulate is complete, steam is introduced into the steam chambers 30, 40 in a manner that is not shown in greater detail, but is intrinsically known and travels from there into the mold cavity 5 according to the arrows H in FIG. 3 via the openings 13 provided in the walls 100, 200. The hot steam there comes into contact with the particles of the granulate that has been poured in and heats their surfaces and the air between the particles so that the particles are melted to form a coherent molded part 6 in accordance with the contour of the mold cavity 5. Because of the circular, conically widening cross-section of the openings 13 in the direction of the mold cavity 5, these are subjected to a self-cleaning effect.

Since in the manner described above, the walls 100, 200 of the molding tools 1, 2 have already been preheated to the required temperatures before the introduction of the steam from the steam chamber 30, 40, the steaming times, such as the time interval during which steam from the steam chambers 30, 40 must be introduced into the mold cavity 5 according to the arrows H in order to melt the particles of the granulate to form the molded part 6, can be extremely short because only the energy quantity, which is required to melt and, if necessary, foam the particles that have been poured in, has to be introduced into the mold cavity 5 by the steam from the steam chambers 30, 40. Because of this only small amount of steam that is introduced into the mold cavity 5, almost no condensate occurs therein that could negatively affect the surfaces of the molded part 6. The produced molded parts 6 thus have outstanding surface properties. In addition, the volume of the steam chambers 30, 40 can be very small so that the molding tool 1, 2 can be embodied as very compact, which in addition to requiring less space, also significantly reduces the mass that must be heated. Specifically, compared to a conventional mold, the heated mass can be reduced by up to 95% and the steam chamber volume can likewise be reduced by up to 95%.

Immediately after the introduction of the required quantity of steam from the steam chambers 30, 40 into the mold cavity 5 according to the arrows H in FIG. 3, the steam chambers 30, 40 are acted on with a negative pressure or vacuum so that the steam in the mold cavity 5 is guided in the opposite direction out of the mold cavity 5 via the openings 13, through the walls 100, 200, and back into the steam chambers 30, 40 and is discharged from there in a manner that is not shown.

Because of the steam chambers 30, 40 being acted on with negative pressure or vacuum, the pressure in the mold cavity 5 also decreases correspondingly and any condensate that has precipitated in the mold cavity 5 and/or the molded part 6 is transformed immediately into the vapor phase because of the residual heat present in the molded part 6 and the walls 100, 200 of the molding tool 1, 2 and is likewise conveyed out via the steam chambers 30, 40.

The application of negative pressure or vacuum to the steam chambers 30, 40 is maintained for a predetermined period of time and/or until the foam pressure falls below a predetermined threshold so that the molded part 6 in the mold cavity 5 is dried and stabilized using just the residual heat together with the applied negative pressure.

Shortly before the demolding of the molded part 6 in the mold cavity 5, a cooling medium such as water is then conveyed via the connecting openings 110, 210 and through the cavity 11 in the walls 100, 200, if necessary, with continued maintenance of the negative pressure in the steam chambers 30, 40, in order to cool the molding tool 1, 2 and the molded part 6 contained therein to the demolding temperature. This achieves a particularly high-quality surface of the molded part 6.

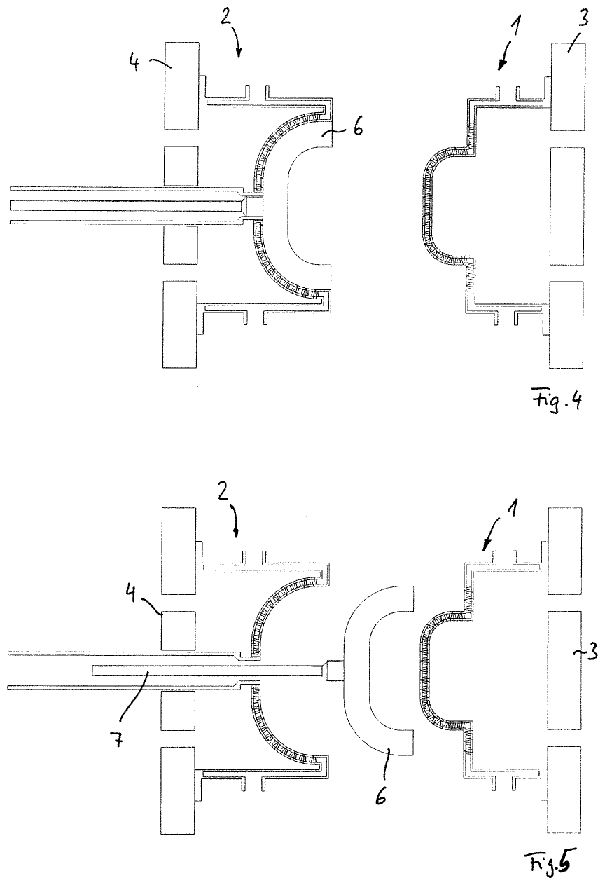

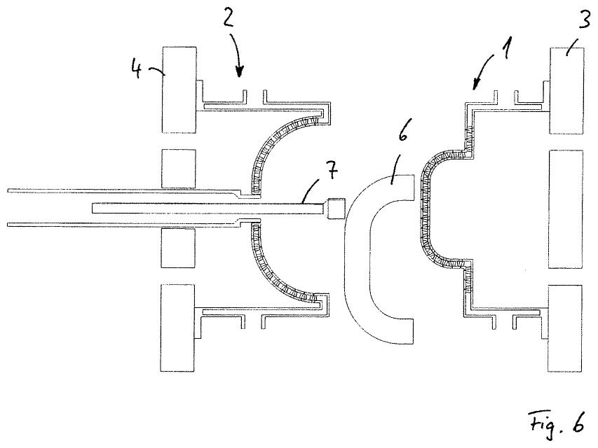

The molding tool can then be opened, as shown in FIG. 4, by moving the supporting plates 3, 4 with the molding tools 1, 2 fastened to them away from each other, thus opening the mold cavity 5. The finished molded part 6 can be removed by an ejector as shown in FIG. 5 and falls out of the mold, as shown in FIG. 6. The procedure can then start again at FIG. 2.

The temperature control medium that is guided in the cavity 11 in the walls 100, 200 in order to preheat the walls 100, 200 and the cooling medium that is guided in the cavity 11 are preferably guided in closed circuits so that the required quantities of temperature control medium and cooling medium are kept low and the energy required for heating or cooling this medium is minimized.

Because the fact of the temperature control medium and/or cooling medium being guided in the third temperature control level in the closed cavity 11 of the molding tool 1, 2 precludes the possibility of an overflow into the steam chambers 30, 40 and/or mold cavity 5, the method steps explained above can be carried out in quick succession and in some cases even simultaneously, resulting in extremely short cycle times of the entire method sequence from FIG. 2 to FIG. 5.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1-12. (canceled)

13. A method for producing a molded part from a foamed plastic in a mold cavity which is delimited by walls of an at least two-part, openable and closable molding tool, comprising the steps of:
a. closing the molding tool to prepare the mold cavity;
b. pouring of a particulate granulate of the plastic into the mold cavity;
c. heating the granulate through the introduction of steam into the filled mold cavity at such a temperature and steam pressure that the granulate is melted to form a molded part;
d. cooling the molded part in the mold cavity; and
e. opening the molding tool and removing the molded part,
wherein the steam that is introduced into the mold cavity is conveyed through steam chambers which are positioned on a side of the walls of the molding tool opposite from the mold cavity and communicate with the mold cavity openings that pass through the walls, wherein before and/or during the closing of the molding tool, a temperature control medium inside the walls of the molding tool is guided in a cavity, which does not communicate with the steam chambers and mold cavity, in order to preheat the walls, and the walls of the molding tool are preheated to a temperature that is suitable for melting the granulate to form the molded part.

14. The method according to claim 13, wherein the walls are preheated to a temperature of approximately 100° C. to 200° C.

15. The method according to claim 14, wherein steam, water, or oil is used as the temperature control medium.

16. The method according to claim 15, wherein guidance of the temperature control medium through the cavity is also maintained during the pouring-in of the granulate in step b).

17. The method according to claim 16, wherein temperature control medium is guided through the cavity in a closed circuit.

18. The method according to claim 17, wherein after the heating in step c), the filled mold cavity is acted on with a negative pressure.

19. The method according to claim 18, wherein application of negative pressure on the filled mold cavity takes place at a temperature of the walls of greater than 70° C. for a predetermined time interval such that the melted granulate in the mold cavity is stabilized.

20. The method according to claim 19, wherein to cool the molded part in the mold cavity of the molding tool in step d), a cooling medium is conveyed through the cavity inside the walls of the molding tool which cavity does not communicate with the steam chambers in order to cool the walls to a demolding temperature.

21. The method according to claim 20, wherein application of negative pressure on the mold cavity continues during and/or after the conveying through of the cooling medium and the cooling of the walls.

22. The method according to claim 21, wherein the cooling medium is guided through the cavity in a closed circuit.

23. The method according to claim 22, wherein during and/or after the heating of the granulate in step c) and before the cooling of the molded part in step d), a hot temperature control medium with a temperature of about 150 to 200° C., preferably approximately 170 to 180° C., is conveyed through the cavity (11).

24. The method according to claim 23, wherein a molding tool having walls that are produced using an additive method and having a cavity extending inside the walls is used, wherein the openings embodied as tubular segments that are isolated from the cavity pass through the cavity between the surfaces of the walls, and the walls, the cavity embodied between them, and the openings that pass through them are integrally embodied of a metallic material.

25. The method according to claim 13, wherein steam, water, or oil is used as the temperature control medium.

26. The method according to claim 13, wherein guidance of the temperature control medium through the cavity is also maintained during the pouring-in of the granulate in step b).

27. The method according to claim 13, wherein temperature control medium is guided through the cavity in a closed circuit.

28. The method according to claim 13, wherein after the heating in step c), the filled mold cavity is acted on with a negative pressure.

29. The method according to claim 13, wherein to cool the molded part in the mold cavity of the molding tool in step d), a cooling medium is conveyed through the cavity inside the walls of the molding tool which cavity does not communicate with the steam chambers in order to cool the walls to a demolding temperature.

30. The method according to claim 13, wherein during and/or after the heating of the granulate in step c) and before the cooling of the molded part in step d), a hot temperature control medium with a temperature of about 150 to 200° C., preferably approximately 170 to 180° C., is conveyed through the cavity (11).

31. The method according to claim 13, wherein a molding tool having walls that are produced using an additive method and having a cavity extending inside the walls is used, wherein the openings embodied as tubular segments that are isolated from the cavity pass through the cavity between the surfaces of the walls, and the walls, the cavity embodied between them, and the openings that pass through them are integrally embodied of a metallic material.

32. The method according to claim 19, wherein application of negative pressure on the mold cavity continues during and/or after the conveying through of the cooling medium and the cooling of the walls.
